(19) United States
(12) Patent Application Publication
(10) Pub. No.: US 2019/0255448 A1
(43) Pub. Date: Aug. 22, 2019

(54) MOBILE ENTERTAINMENT CENTER

(71) Applicant: Joshua Holston, Osceola, IN (US)

(72) Inventor: Joshua Holston, Osceola, IN (US)

(21) Appl. No.: 15/900,814

(22) Filed: Feb. 21, 2018

(51) Int. Cl. A63F 13/90; A63D 15/00; A63F 7/06; A63F 13/837; A63F 13/24; A63G 31/00; A63F 13/85; F41J 3/00

(52) U.S. Cl. CPC A63F 13/90; A63D 15/00; A63F 7/066; A63F 7/0672; G06F 3/04842; A63F 13/24; A63G 31/00; A63F 13/85; F41J 3/0009; A63F 13/837

(57) ABSTRACT

A mobile entertainment trailer, including at least one video game system disposed within the mobile entertainment trailer, at least one light disposed within the mobile entertainment trailer, a jukebox to play music within the mobile entertainment trailer, and a control panel disposed within the mobile entertainment trailer to control operation of the at least one light and the jukebox.

### BACKGROUND

### 1. Field

The present general inventive concept relates generally to a trailer, and specifically, to a mobile entertainment trailer.

### 2. Description of the Related Art

Special events call for exciting and interesting party planning, and event planners are always looking for the newest, and most interesting ideas that can entertain a diverse group of people regardless of age or skill set. However, not many event facilities or rental companies can offer extensive, inclusive entertainment experiences that can also be brought to one's door.

Therefore, there is a need for a mobile unit that provides entertainment for parties and events.

### SUMMARY

The present general inventive concept provides a mobile entertainment trailer.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a mobile entertainment trailer, including at least one video game system disposed within the mobile entertainment trailer, at least one light disposed within the mobile entertainment trailer, a jukebox to play music within the mobile entertainment trailer, and a control panel disposed within the mobile entertainment trailer to control operation of the at least one light and the jukebox.

The at least one video game system may include at least one of a stand-up arcade-style video game system, a sit-down arcade-style video game system, a shooter game system, a joystick game system, an electronic dart board, a billiards table, an air hockey table, a foosball table.

The mobile entertainment trailer may further include a vent to selectively output warm air and cold air, based on input received at the control panel.

The jukebox may include at least one of a plurality of compact discs and a storage unit including a plurality of MP3 files.

The plurality of MP3 files may be stored within the control panel.

The mobile entertainment trailer may further include a ramp disposed below a base of the mobile entertainment trailer to allow users to access an inner portion of the mobile entertainment trailer via a rear portion of the mobile entertainment trailer, and a retractable table disposed within a floor of the mobile entertainment trailer to be selectively extractable via the control panel.

The control panel may include a touch screen.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a mobile entertainment trailer, according to an exemplary embodiment of the present general inventive concept.

### DETAILED DESCRIPTION OF THE INVENTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

The present general inventive concept relates to a beverage dispensing tray that is placed under a beverage dispenser to secure or to provide a spillage area for a beverage dispenser. Typically, a beverage dispenser has a spout that allows a user to obtain fluids from the beverage dispenser. Many times during filling of cups or other vessels, a user has spillage near and around the beverage dispenser. The present invention includes a tray that has a base component at the center of the tray. Surrounding the tray are beveled walls that surround a catch surface within the beverage tray. During use, a user will place a beverage dispenser in the center of the tray, therefore allowing the catch surface to catch any spillage from the beverage dispenser.

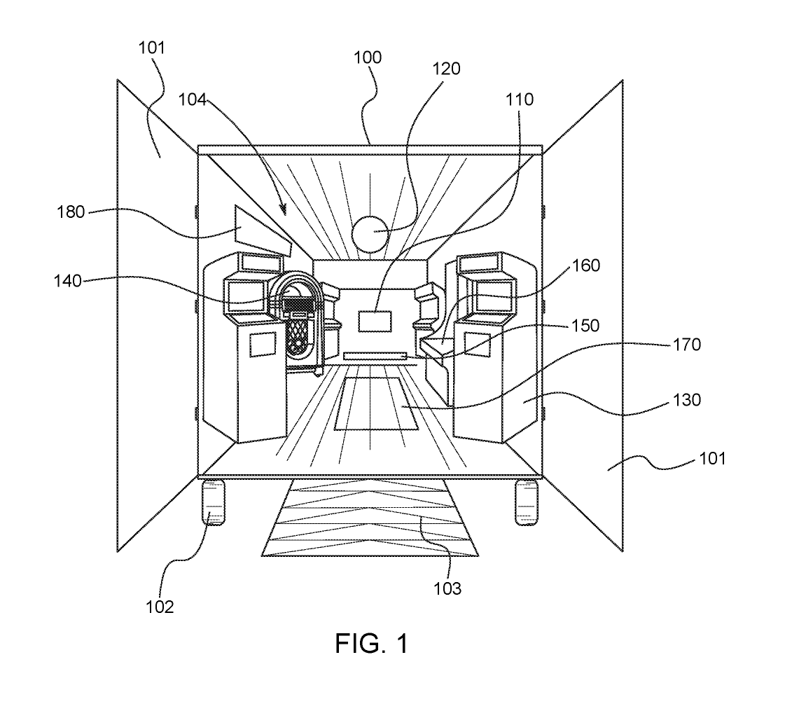

FIG. 1 illustrates a mobile entertainment trailer 100, according to an exemplary embodiment of the present general inventive concept.

The mobile entertainment trailer 100 may include doors 101, wheels 102, and a ramp 103.

The doors 101 may be disposed at a rear portion of the mobile entertainment trailer 100, such that an inner portion 104 of the mobile entertainment trailer 100 is accessible when the doors 101 are opened.

The wheels 102 may be disposed to a base of the mobile entertainment trailer 100, and may allow the mobile entertainment trailer 100 to be movable when pulled by another external vehicle that is connected to the mobile entertainment trailer 100.

The ramp 103 may be disposed beneath a bottom surface of the mobile entertainment trailer 100, such that the ramp 103 may be slid out to allow people to easily climb into the inner portion 104 via a rear portion of the mobile entertainment trailer 100. Since the ramp 103 has a predetermined incline, the mobile entertainment trailer 100 may be handicap accessible.

The mobile entertainment trailer 100 may include a control panel 110, at least one light 120, at least one video game system 130, a jukebox 140, a vent 150, a seat 160, and a retractable table 170.

Walls of the mobile entertainment trailer 100 may include outlets to allow electrical components within the mobile entertainment trailer 100 to receive power.

The control panel 110 may be a display screen and/or a touch screen that allows users to control various aspects of the mobile entertainment trailer 100. More specifically, a user may be connected to and control any and/or all of the at least one light 120, the at least one video game system 130, the jukebox 140, the vent 150, and the retractable table 170. Also, the control panel 110 may be connected to at least one television 180 that can display various television programs, sporting events, and/or movies, and which may be controlled by the control panel 110.

As such, the control panel 110 may include a processor, a communication system, Internet connectivity capabilities, a storage unit, an input unit, a storage unit, and a control unit, in order to be able to communicate with the other components within the mobile entertainment trailer 100.

The control panel 110 may display thereupon music choices, lighting choices, sound options, temperature selections, Internet connections, and television channel choices, which may all be selected via the control panel 110.

The at least one light 120 may be any type of light system, including, but not limited to, incandescent lights, fluorescent lights, light emitting diodes (LEDs), halogen lights, etc.

The at least one light 120 may be controlled via the control panel 110 to change into any color desired by the user, including, but not limited to, white, red, orange, yellow, green, blue, indigo, violet, pink, teal, and also, blacklight. The colors may also be played on a loop, may change gradually to fade into various different colors, or may be strobed, based on the user's preference and based on the user's manipulation of the control panel 110.

The at least one video game system 130 may be a stand-up arcade-style video game system, a sit-down arcade-style video game system, a shooter game system, a joystick game system, an electronic dart board, a billiards table, an air hockey table, a foosball table, etc., but is not limited thereto. The above at least one video game system 130 may be electronic or non-electronic, depending on the type of the at least one video game system 130.

The jukebox 140 may be an old-style jukebox with records included therewith, a new-style jukebox with compact discs included therewith, or a modern jukebox with thousands of MP3s. The jukebox 140 may include a control panel and speakers, and alternatively, speakers connected to the jukebox may be distributed along the inner portion 104 of the mobile entertainment trailer 100.

The jukebox 140 may be controlled at the jukebox 140, or alternatively, may be controlled at the control panel 110 to increase/decrease volume of the speakers, and/or search to find music playable by the jukebox 140. Alternatively, the jukebox 140 may be solely a part of the control panel 110, in order to allow space to be conserved within the mobile entertainment trailer 100.

The vent 150 may control temperature within the mobile entertainment trailer 100. More specifically, the vent 150 may blow warm air and/or cool air to regulate the temperature within the mobile entertainment trailer 100. The vent 150 may be controlled by the control panel 110.

The seat 160 may be a bench, foldable seat, etc., but is not limited thereto. The seat 160 may allow people waiting to play video games have a place to sit.

The retractable table 170 may be disposed within a floor of the mobile entertainment trailer 100, and may be extracted manually or by use of the control panel 110. The retractable table 170 may be extracted to be used as a table upon which to set beverages and/or food, or alternatively, may be used as a surface upon which to play beer pong.

Also, although not illustrated expressly herein, the mobile entertainment trailer 100 may include a wet bar therein, as well as various configurations of components therewithin.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A mobile entertainment trailer, comprising:
at least one video game system disposed within the mobile entertainment trailer;
at least one light disposed within the mobile entertainment trailer;
a jukebox to play music within the mobile entertainment trailer; and
a control panel disposed within the mobile entertainment trailer to control operation of the at least one light and the jukebox.

2. The mobile entertainment trailer of claim 1, wherein the at least one video game system comprises at least one of a stand-up arcade-style video game system, a sit-down arcade-style video game system, a shooter game system, a joystick game system, an electronic dart board, a billiards table, an air hockey table, a foosball table.

3. The mobile entertainment trailer of claim 1, further comprising:
a vent to selectively output warm air and cold air, based on input received at the control panel.

4. The mobile entertainment trailer of claim 1, wherein the jukebox comprises at least one of a plurality of compact discs and a storage unit including a plurality of MP3 files.

5. The mobile entertainment trailer of claim 4, wherein the plurality of MP3 files are stored within the control panel.

6. The mobile entertainment trailer of claim 1, further comprising
a ramp disposed below a base of the mobile entertainment trailer to allow users to access an inner portion of the mobile entertainment trailer via a rear portion of the mobile entertainment trailer; and
a retractable table disposed within a floor of the mobile entertainment trailer to be selectively extractable via the control panel.

7. The mobile entertainment trailer of claim 1, wherein the control panel comprises a touch screen.
